(19) United States
(12) Patent Application Publication
(10) Pub. No.: US 2017/0340152 A1
(43) Pub. Date: Nov. 30, 2017

(54) Stackable Disposable Utensils

(71) Applicant: SAMKO Limited, Hong Kong (CN)

(72) Inventor: Ching Mou Lee, Taikoo Shing (CN)

(73) Assignee: SAMKO Limited, Hong Kong (CN)

(21) Appl. No.: 15/376,396

(22) Filed: Dec. 12, 2016

Related U.S. Application Data
(63) Continuation-in-part of application No. 29/566,105, filed on May 26, 2016, now Pat. No. D778122.
Application No. 29/566,105 is a continuation-in-part of application No. 29/566,109, filed on May 26, 2016, now Pat. No. D778121.
Application No. 29/566,109 is a continuation-in-part of application No. 29/566,110, filed on May 26, 2016, now Pat. No. D778123.
Application No. 29/566,110 is a continuation-in-part of application No. 29/566,111, filed on May 26, 2016, now Pat. No. D778124.
Application No. 29/566,111 is a continuation-in-part of application No. 29/566,112, filed on May 26, 2016, now Pat. No. D778120.

(51) Int. Cl. A47G 21/02; A47G 21/04; B26B 3/02

(52) U.S. Cl. CPC A47G 21/02; B26B 3/02; A47G 21/023; A47G 21/04

(57) ABSTRACT

Stackable Disposable Utensils. The spoon, soup spoon, spork, fork and knife are all be stackable with like items so that the most compact package is provided. The handles have a W-shaped cross-section defined by a raised peak in its center, leading to a pair of valleys adjacent thereto, and terminating in slightly raised outer edges. Furthermore, the tail end of each utensil terminates in a downwardly-sloped portion to further add strength.

This application is a continuation in part of application Ser. Nos. 29/566,105, 29/566,109, 29/566,110, 29/566,111 and 29/566,112, all filed May 26, 2016, all now pending.

### BACKGROUND OF THE INVENTION

### 1. Field of the Invention

This invention relates generally to eating utensils and, more specifically, to Stackable Disposable Utensils.

### 2. Description of Related Art

Based on the shape of the handle, there are two categories of disposable plastic cutlery existing in the current market—the non-stackable and the stackable. The stackable has more advantages to reduce at least 10% raw material during production and packaging process, while over 20% of storage and transportation fees are saved.

Polypropylene or Polystyrene are the typical raw materials used for construction of disposable cutlery as the raw material, the handle of the plastic cutlery can be quite fragile and thin or sharp forms such as the blade tend to be breakable. As a reulst, the user and surrounding people are exposed to the potential safety hazard with the broken handle and fragments scattering at a high speed.

The cross-sectional structure of these products is the key to solve the issues caused by the nature of material. The strength-to-density ratio varies in different sections of the handle, affecting by its width, length, thickness and shape. The breaking points are usually located at the section with lowest ratio of strength to density.

One of the popular methods to reduce the breakage is to make the handle thicker, such as the rib reinforcement at the weak point. However, while this approach has reduced the fragility of the product, there is still a strength problem in the handle. In fact, the issue could be worsened after installing an X-shaped rib reinforcement at the rear of the handle. More stress can be produced at the rib while the surrounding areas become increasingly fragile, which might lead to more harm if broken because the rib many times will remain unbroken. Also, the problem related to the higher cost of production is not solved.

The structure of the handle plays an important role in balancing the strength, weight, brittleness as well as the stackability. Currently, there are four categories of handle cross-section on the market:

1. Straight-Line-Shaped Cross Section.
This design is more suitable for heavy duty tableware than the plastic cutlery. The handle defines a sheet shape with low strength in the vertical direction that can be bent easily. To attempt to resolve this, the handles are either thickened or reinforced with upper and lower projecting edges along both sides. However, this design still allows the handle to be slippery. Additionally, this design does not allow the cutlery to be stacked up, and thus has higher cost of packaging and storage.

2. n-Shaped Cross Section.
This prior design has a handle cross-section that is “N-shaped,” with the handle defining either a straight line, an [symbol] -shape line or an arcuate line. Different effects will be created, due to the varied angle between the n-shaped handle's two sides and the surface. If the height of the two sides over 50 percent of the width of the surface, the strength and bending resistance of the handle will be better than the straight-line-shaped handle. However, if the handle is thin, the defects of being fragile will still exist. In order to increase its strength and elasticity, the traditional way is to sacrifice the cost of the raw material by adding a reinforcement rib with an X-shape at the rear of the handle. The contrast between the X-shaped reinforcement rib and surrounding area, leads to a more hazardous situation for breakage. The x-shaped rib would also prevent stacking.

3. Obtuse Angle Between Handle Surface and Both Sides.
For this design, the thickness of the handle's two sides is closed to the width of its surface. If the obtuse angle is arranged properly, the cutlery can be nested and stacked high. On the other hand, the handle's strength and elasticity will decrease as the angle increases. Although this design is stackable, this advantage has been balanced out by the increased thickness and the additional cost of raw material required in order to have a strong enough handle.

4. [symbol] -Shaped or V-Shaped
This design embodies the left and right sides of the handle forming an angle of less than 180 degrees (which will make the utensil stackable). However, in order to provide sufficient strength, an x-shaped rib has also been included (which prevents stackability).

What is needed, then, is a design for disposable cutlery that is light, stackable and strong enough to inhibit breaking.

### SUMMARY OF THE INVENTION

In light of the aforementioned problems associated with the prior devices, it is an object of the present invention to provide a Stackable Disposable Utensil design. The spoon, soup spoon, spork, fork and knife should all be stackable with like items so that the most compact package is provided. The handles should have a W-shaped cross-section defined by a raised peak in its center, leading to a pair of valleys adjacent thereto, and terminating in slightly raised outer edges. Furthermore, the tail end of each utensil should terminate in a downwardly-sloped portion to further add strength.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a preferred embodiment of a fork of the present invention;

FIG. 2 is a top view thereof;

FIG. 3 is a bottom view thereof;

FIG. 4 is a cutaway side view thereof;

FIG. 5 is a bottom perspective view thereof;

FIG. 6 is a side view thereof;

FIG. 7 is a cutaway transverse view of the handle of the fork of FIG. 1;

FIG. 8 is a cutaway transverse view of the tines of the fork of FIG. 1;

FIG. 9 is a perspective view of a stack of the forks of FIG. 1;

FIG. 10 is a cutaway transverse view of the handles of the stack of FIG. 9;

FIG. 11 is a perspective view of a preferred embodiment of a spoon of the present invention;

FIG. 12 is a perspective view of a preferred embodiment of a soup spoon of the present invention;

FIG. 13 is a perspective view of a preferred embodiment of a spork of the present invention; and

FIG. 14 is a perspective view of a preferred embodiment of a knife of the present invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide Stackable Disposable Utensils.

In order to solve the above technical problems, it is necessary to introduce a novel handle design that is light, strong with low brittleness and is stably stackable, for plastic fork, spoon and knife etc.

The present design produces a novel cutlery, comprising a handle portion, and food-access or tip portion. The cutlery is further defined by a handle having a neck portion connected with the food access unit and a tail portion (handle) extending away from it.

The cross section of handle for the novel cutlery is similar to W-shape with two inner lines and two outer lines. The two inner lines are divided symmetrically by the axis of the handle with the top joined and bottom separated, which forms a [symbol] -shape. Locating further along the axis, the bottom of the two outer lines are joined with the bottom of the inner lines respectively while their tops are separated and forms two small V-shapes. Additionally, the upper side of the outer line has been turned horizontally, which produces two reinforcement sheets having a polygon shape. Meanwhile, two symmetrical sections with N shape forms respectively at both sides of the axis where the inner section is higher than the outer one.

The [symbol] -shape, as mentioned above, extends along the central axis until it reaches the food operational portion and forms the main handle portion, which is similar to an open triangle. This design is more advantageous with higher strength and elasticity.

The enforcement sheets, extending from the rear end to the neck portion of the handle and connecting with the food operational portion, is strong enough to share the stress on the handle. Specifically, they play an important role in preventing bending and distortion caused by pressure at both sides of the handle.

The two opposing symmetrical sections with N shape run through the handle along the axis and join with the food engagement portion, thus making the W-shape handle as a whole.

The W-shape of the handle makes it possible for the convex groove with the [symbol] at the front can be nested with the V-shape notch formed on the back-side. The gap between the stacked cutlery has thus been minimized. It is a structure that largely reduces the storage requirement. In addition to this, the small V-shapes at the bottom will stabilize the stacked cutlery.

When utilized properly by users, the novel cutlery can stand the stress from all direction. The chance of bending is low, especially with the enforcement sheets sharing the pressure and avoiding the displacement of both sides of the handle.

The handle of the novel cutlery cannot be easily broken even if an extraordinary amount of pressure is placed on it to force it to bend. As there is no necessary to add the X-shape reinforcement grids, the stress will spread evenly along the handles of the cutlery, and no weak point will be formed. When the pressure is placed vertically either from the back or front of the handle, it will transfer to the top of the [symbol] -shape first and then to the two inner side ridges. The outer sides and the reinforcement sheets thereon move horizontally as distortion occurs. The molecular chain of the polypropylene will be arranged to form a more unbreakable structure. Therefore, it will prevent the risk of breakage and the related hazard.

This novel cutlery also has a weight advantage. The inner sides with A-shape comprises over 70% of the total area of the W-shape handle. Therefore the weight of the handle portion will drop noticeably because the thickness of this portion can be reduced.

The handle portion and tip portion are injected into the mold as a single part with the polypropylene as the raw material. As shown by the lab data and practical usage, the novel cutlery has advantage of being lightweight, strong, and further can be nested or stacked stably. By minimizing the gap between the individual items of stacked cutlery, the cost of package and storage has been reduced tremendously while the products are much safer and more environmental friendly.

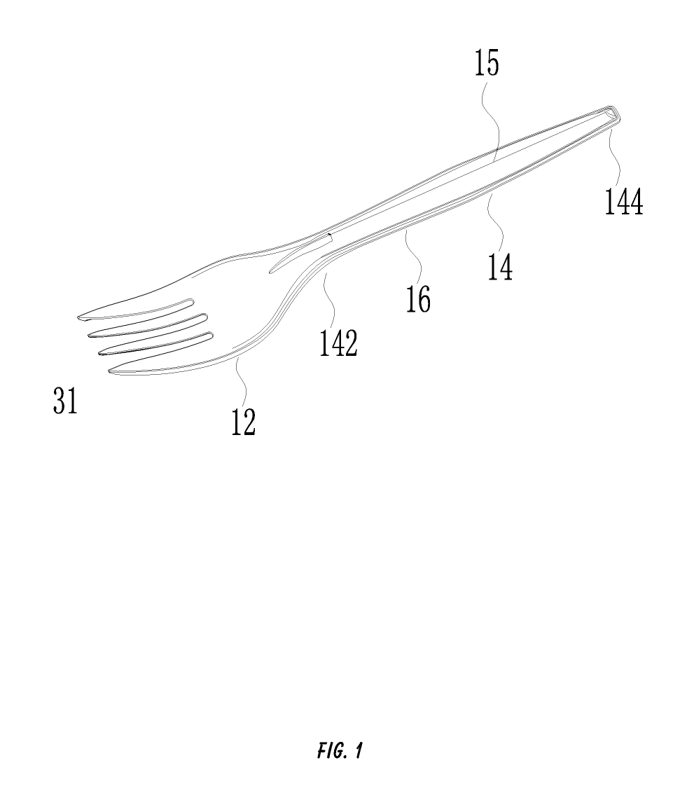

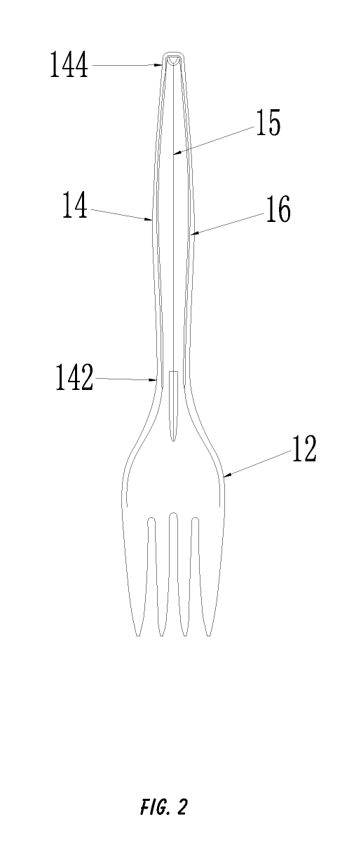

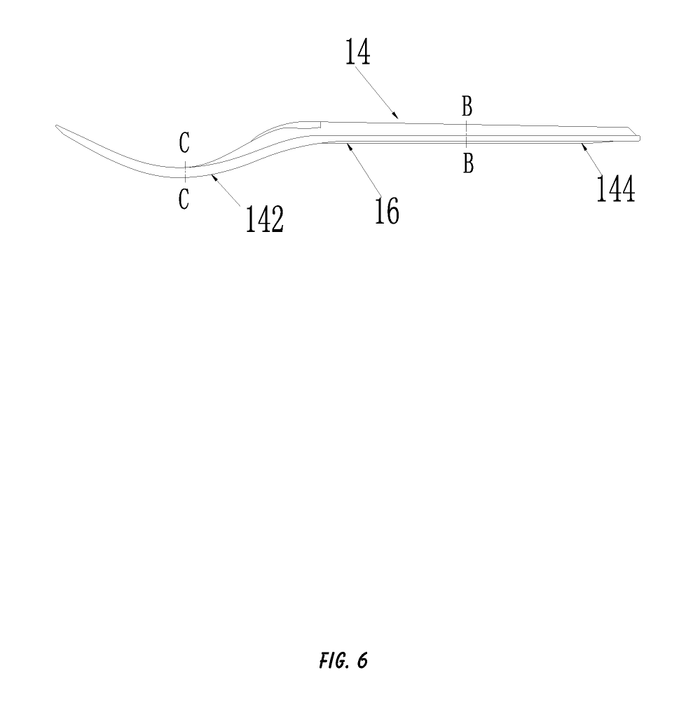

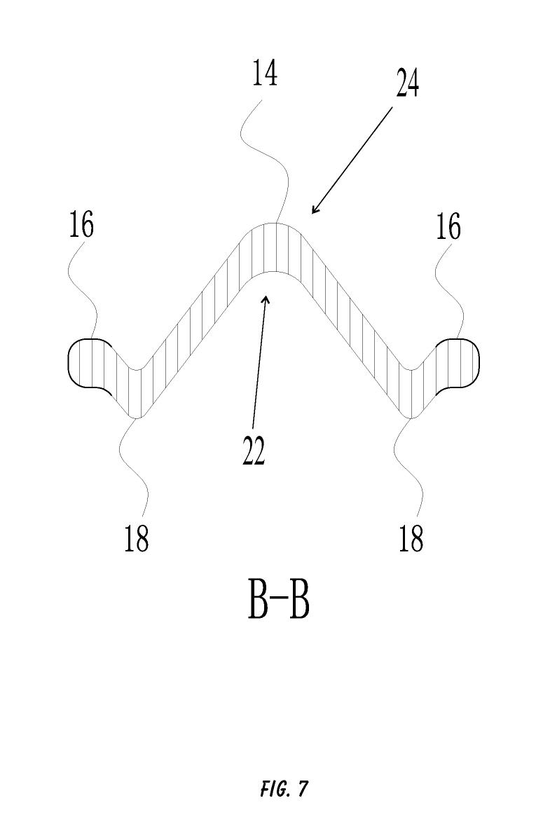

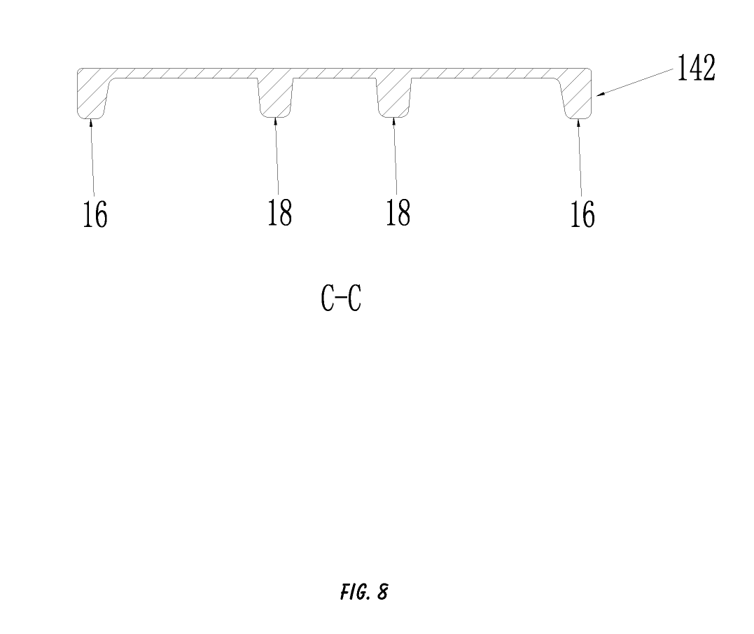

We will now reference drawing FIGS. 1, 3, 5, 6, 7 and 8, wherein a preferred embodiment of the fork 31 is depicted. All utensils comprise the food operational portion 12 and handle portion 14. Handle 14 includes the neck end 142 near the food operational portion 12 and the tip end 144. The cross section of handle 14 has a W-shape as illustrated in FIG. 7, and includes reinforcement rib 16 at the outer two edges. Reinforcement ridges 16 extending from the tip end 144 to the food operational portion 12 as shown in FIGS. 1 & 8.

The W-shaped handle portion 14 and reinforcement rib of [symbol] -shape at the back results in the fork not being prone to distortion when the food operational portion 12 is stressed during usage. With the reinforcement rib 16 of small v-shape and the structure of the handle portion 14, it is much stronger and more comfortable for users.

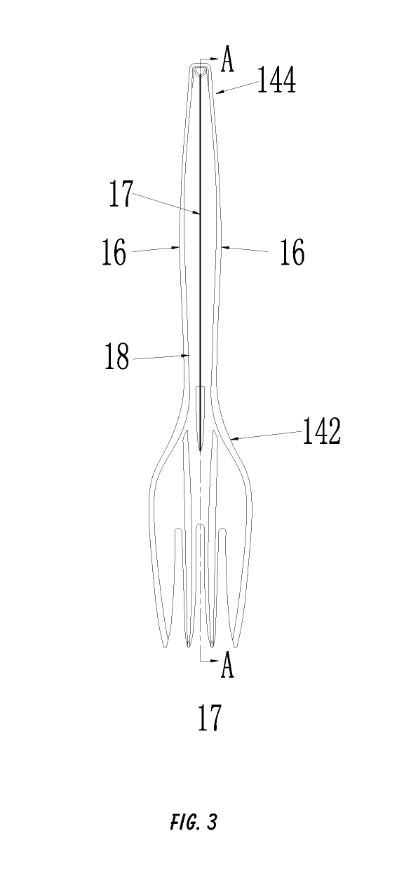

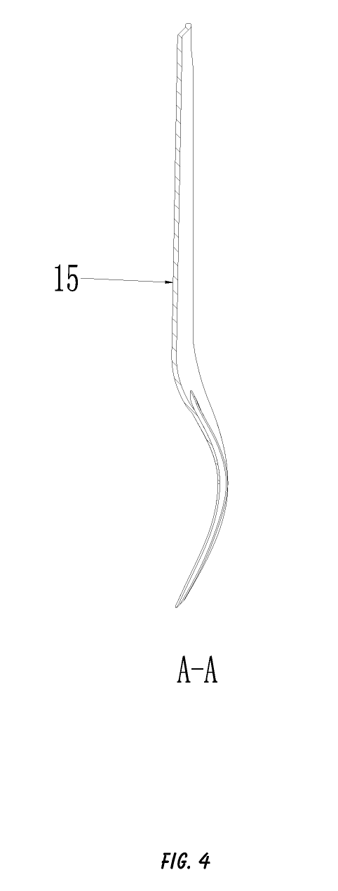

Referring now to FIGS. 3 to 5, the handle portion 14 has been strengthened by the reinforcement ridge 18 and reinforcement rib 16 as illustrated in FIG. 7. The food operational portion is connected with the handle by the reinforcement rib formed in a small triangular shape. Comparing with the traditional fork, it is safer, lighter, as well as more comfortable and environment friendly, while the cost of production has been reduced tremendously by the reduction of raw material required.

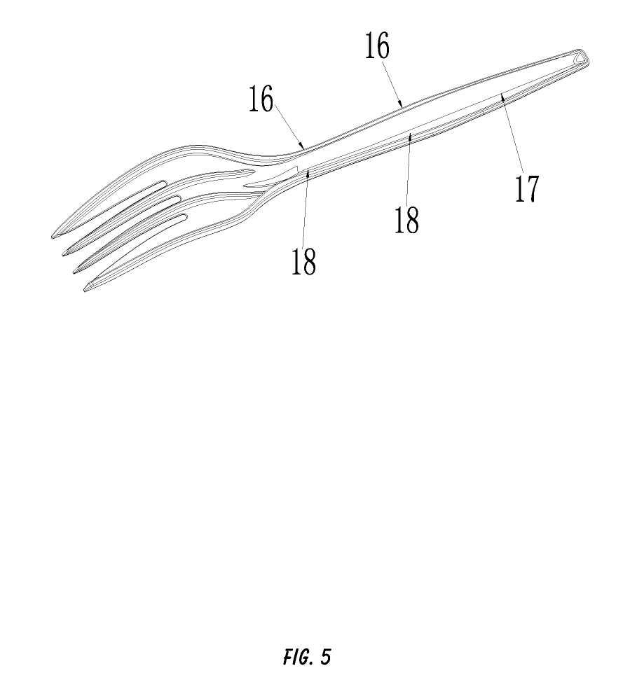

As illustrated in FIG. 5, the reinforcement ridge 18 of small triangle shapes extend from the neck end 142 to the tip 144 while the reinforcement rib 16 at the outer edge spreading parallel from the top 142 to 144. It has increased the strength of convex groove 15 at the top surface and the notch 17 on the bottom. The bending stiffness of handle portion 14 has been improved without additional material being required. The food operational portion 12 and handle 14 is injected with mold as a single piece.

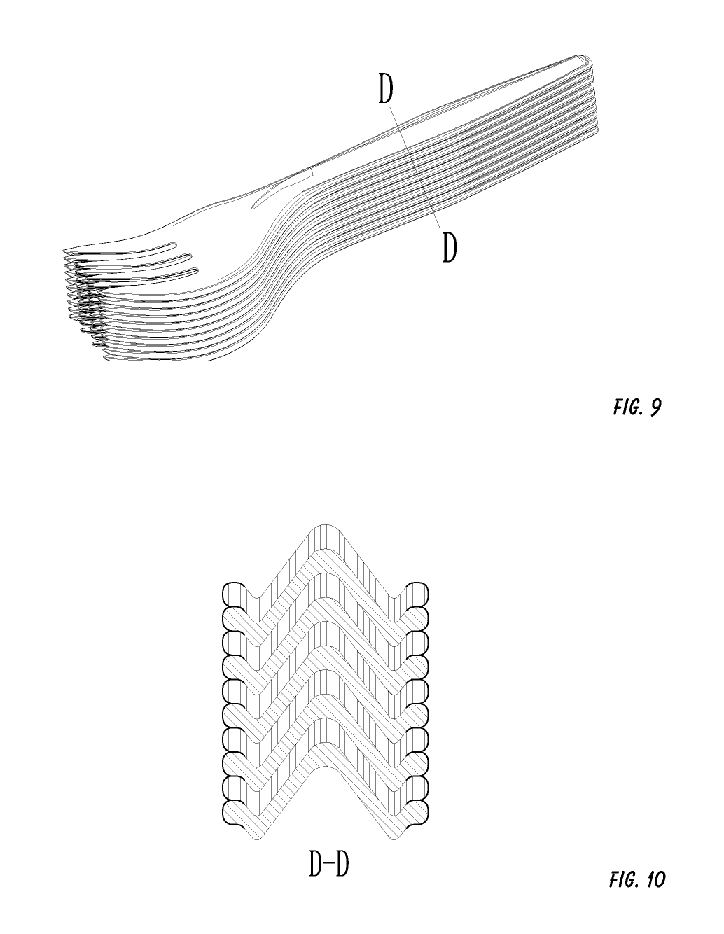

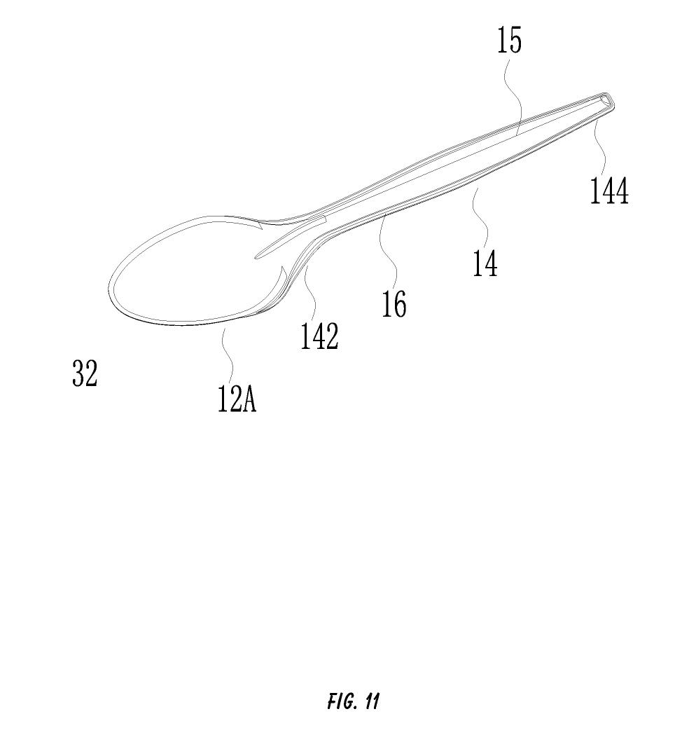

As claimed, the novel cutlery can be nested closely as illustrated in FIGS. 9 & 10. It makes it possible for each pile of cutlery such as fork, spork, spoon to be stacked stably, which will reduce the storage and increase the efficiency of packaging.

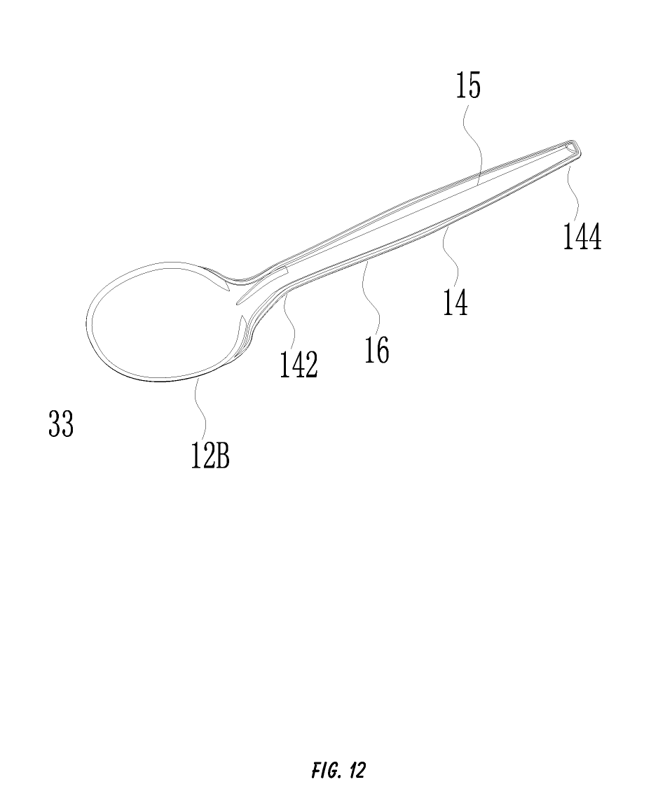

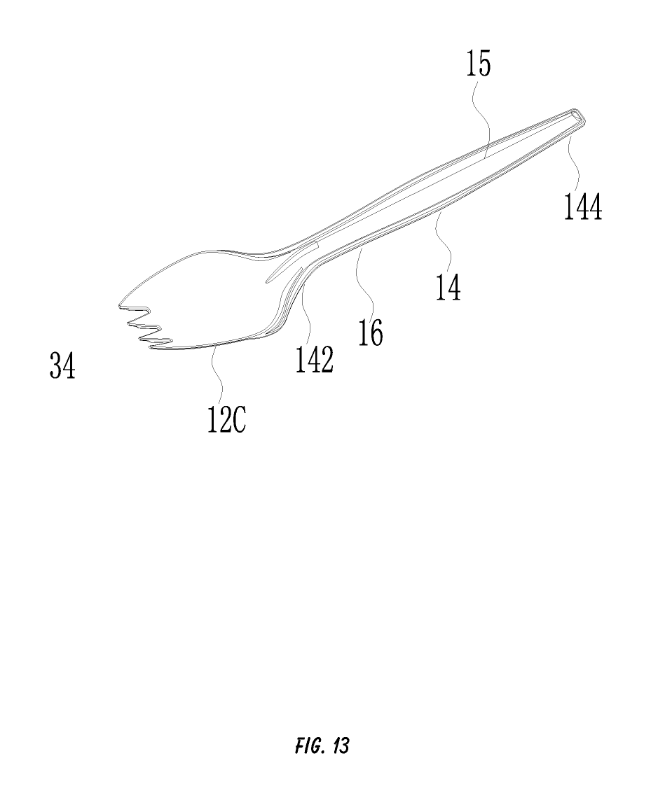

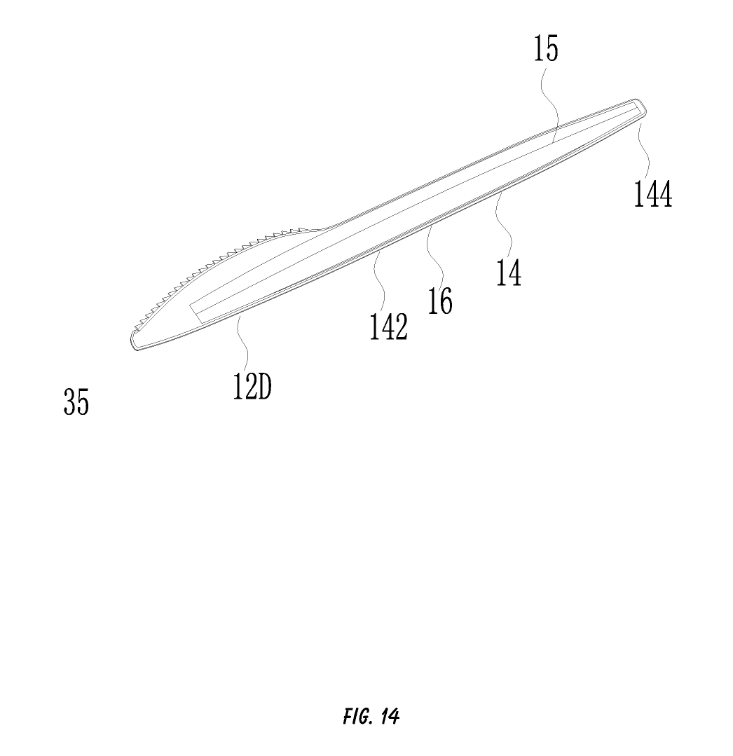

This design is also practical for other types cutlery, such as the Spoon of FIG. 11, the Soup Spoon of FIG. 12, the Spork of FIG. 13 and the Knife of FIG. 14. The new W-shaped handle portion design disclosed may also be embodied in other specific forms without departing from the spirit or the general characteristics, any changes and modifications which come within the meaning and range of the equivalency of the design are intended to be embraced therein.

### Element Listing

12: Food operational and engagement portion
14: Handle portion
15: Handle top side ridge peak
16: Peripheral ridge portion
17: Handle back side ridge peak
18: Peripheral bottom side ridge peak
22: The notch
24: The convex groove
32: Spoon
33: Soup spoon
34: Spork
35: Knife.
142: handle neck end
144: handle tip end

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A stackable cutlery item, comprising:
a handle portion extending from a tip end to a neck end;
a food engagement portion; and
wherein said handle portion comprises a central downwardly-turned V-shape extending from said tip end to said neck end and a pair of upwardly-turned V-shapes at opposing side edges of said handle portion.

2. The item of claim 1, wherein said food engagement portion defines a spoon, a soup spoon, a knife, a fork or a spork.

3. The item of claim 2, wherein said handle portion is comprised of ribs forming the termination of said opposing side edges thereof.

4. The item of claim 3, wherein said tip end of said handle portion comprises a transverse-oriented slope portion extending from the upper ridge of said V-shape to said tip end.

5. A cutlery item comprising:
a head portion extending from a tip to a neck portion;
a handle portion extending from said neck portion to a tail end, said handle portion defining a longitudinal axis and defined by a W-shaped cross-section, said W-shaped cross-section comprising:
a central ridge;
opposing walls extending downwardly from said central ridge and terminating in a pair of opposing lower ridges;
opposing walls extending upwardly from each said lower ridge and terminating in outer ridges.

6. The item of claim 5, wherein said food engagement portion defines a spoon, a soup spoon, a knife, a fork or a spork.

7. The item of claim 6, wherein said tip end of said handle portion comprises a transverse-oriented slope portion extending from said central ridge of said W-shape to said tail end.

8. A group of cutlery, wherein each member of said group comprises:
a handle portion extending from a tip end to a neck end;
a food engagement portion; and
wherein said handle portion comprises a W-shaped cross-section, said W-shaped cross-section defined by a central downwardly-turned V-shape extending from said tip end to said neck end and a pair of upwardly-turned V-shapes at opposing side edges of said handle portion.

9. The group of claim 8, wherein said handle portion of each said member of said group is comprised of ribs, each said rib forming the termination of said opposing side edges thereof.

10. The group of claim 9, wherein said food engagement portion of each said member of said group defines a spoon, a soup spoon, a knife, a fork or a spork.

11. The group of claim 10, wherein said tip end of said handle portion comprises a transverse-oriented slope portion extending from the upper ridge of said V-shape to said tip end.
